(19) United States
(12) Patent Application Publication
(10) Pub. No.: US 2016/0095061 A1
(43) Pub. Date: Mar. 31, 2016

(54) REDUCED POWER CONSUMPTION USING COORDINATED BEACON SKIPPING

(71) Applicant: Apple Inc., Cupertino, CA (US)

(72) Inventors: Koby Vainapel, Ra'anana (IL); Merav Fridman, Ra-anana (IL); Yossef Yatir, Kiryat Ono (IL); Yoel Boger, Ra-anana (IL); Itay I. Gadassi, Givatayeem (IL); Hay Lev, Gan Yavne (IL)

(21) Appl. No.: 14/502,064

(22) Filed: Sep. 30, 2014

(51) Int. Cl. H04W 52/02

(52) U.S. Cl. CPC H04W 52/0225; H04W 84/12

(57) ABSTRACT

In order to reduce the power consumption associated with waking and receiving beacons, a current listening device in a group of electronic devices wakes and scans for a beacon from another electronic device (such as an access point) using a wireless-local-area-network (WLAN) communication protocol (such as Wi-Fi®). Then, the current listening device transmits information associated with the beacon to the group of electronic devices using a second communication protocol (such as Bluetooth® Low Energy), which is different than the WLAN communication protocol and has a lower power consumption. Moreover, the current listening device receives, using the second communication protocol, a sequence of responses from the group of electronic devices indicating that the information was received, wherein the responses from different electronic devices are received at different times. For example, the responses may be received in a predefined order and/or in round-robin fashion for the group of electronic devices.

### BACKGROUND

1. Field

The described embodiments relate to techniques for reducing power consumption by skipping the receiving of beacons in a wireless network.

2. Related Art

Many modern electronic devices include a networking subsystem that is used to wirelessly communicate with other electronic devices. For example, these electronic devices can include a networking subsystem with a cellular network interface (UMTS, LTE, etc.), a wireless local area network interface (e.g., a wireless network such as described in the Institute of Electrical and Electronics Engineers (IEEE) 802.11 standard or Bluetooth® from the Bluetooth Special Interest Group of Kirkland, Wash.), and/or another type of wireless interface.

In many wireless-communication protocols, electronic devices detect each other by regularly broadcasting beacons and scanning for the beacons from other electronic devices. For example, an electronic device that communicates with another electronic device in a wireless network using a communication protocol that is compatible with an IEEE 802.11 standard (which is sometimes referred to as ‘Wi-Fi’) may wake up its radio periodically to receive a beacon frame at beacon transmission time intervals.

However, regularly transmitting and receiving these beacons typically results in significant power consumption by the networking subsystems. Therefore, existing communication techniques in wireless networks that regularly transmit and receive such beacons may reduce the operating time of the electronic device, which can degrade the user experience.

### SUMMARY

The described embodiments relate to the design of a first electronic device that communicates on a wireless network. This first electronic device includes: an antenna; and an interface circuit, coupled to the antenna, which communicates with a second electronic device and a group of electronic devices, where the first electronic device functions as a listening device for the group of electronic devices. During operation, the interface circuit scans for a beacon transmitted by the second electronic device using a wireless local area network (WLAN) communication protocol. Then, the interface circuit transmits information associated with the beacon to the group of electronic devices using a second communication protocol, where the second communication protocol is different than the WLAN communication protocol. Next, the interface circuit receives, using the second communication protocol, a sequence of responses from the group of electronic devices indicating that the information was received, where the responses from different electronic devices are received at different times.

Note that the second communication protocol may be associated with lower power consumption than the WLAN communication protocol. For example, the WLAN communication protocol may include Wi-Fi® and the second communication protocol may include Bluetooth® Low Energy.

Moreover, after receiving the responses, the interface circuit may transmit group status information about electronic devices in the group of electronic devices. For example, the group status information may include: a list of the electronic devices in the group of electronic devices; and a schedule indicating when the electronic devices in the group of electronic devices function as listening devices.

Furthermore, when one of the group of electronic devices other than the first electronic device functions as the listening device, the interface circuit may: receive information associated with another beacon from the one of the group of electronic devices; and transmit a response to the one of the group of electronic devices that indicates the information was received, where the response is transmitted based on the predefined order for the group of electronic devices.

Additionally, prior to scanning for the beacon, the interface circuit may transition from a lower power-consumption mode to a higher power-consumption mode. Moreover, after scanning for the beacon, the interface circuit may transition from the higher power-consumption mode to the lower power-consumption mode.

In some embodiments, the interface circuit: receives a request from a third electronic device to join the group of electronic devices; and, in response to the request, adds the third electronic device to the group of electronic devices.

Note that the responses may be received in a predefined order for the group of electronic devices. Alternatively or additionally, the responses may be received in round-robin fashion from the group of electronic devices.

Moreover, the second electronic device may transmit beacons at a time interval defined by a first period, and the first electronic device may scan for the beacons at a time interval defined by a second period, where the first period may be less than the second period.

Furthermore, the second electronic device may include an access point.

Another embodiment provides a first electronic device in which a program module, stored in memory and executed by a processor, performs at least some of the aforementioned operations of the interface circuit.

Another embodiment provides a computer-program product for use with the first electronic device. This computer-program product includes instructions for at least some of the operations performed by the first electronic device.

Another embodiment provides a method for functioning as the listening device for the group of electronic devices, where the method may be performed by the first electronic device. During operation, the first electronic device scans for the beacon transmitted by the second electronic device using the WLAN communication protocol. Then, the first electronic device transmits the information associated with the beacon to the group of electronic devices using the second communication protocol, where the second communication protocol is different than the WLAN communication protocol. Next, the first electronic device receives, using the second communication protocol, the sequence of responses from the group of electronic devices indicating that the information was received, where the responses from the different electronic devices are received at different times.

This Summary is provided merely for purposes of illustrating some exemplary embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating electronic devices wirelessly communicating in accordance with an embodiment of the present disclosure.

FIG. 2 is a timing diagram illustrating communication among the electronic devices of FIG. 1 in accordance with an embodiment of the present disclosure.

FIG. 3 is a drawing illustrating a post-beacon message during the communication among the electronic devices of FIG. 1 in accordance with an embodiment of the present disclosure.

FIG. 4 is a drawing illustrating a response message during the communication among the electronic devices of FIG. 1 in accordance with an embodiment of the present disclosure.

FIG. 5 is a drawing illustrating a group-member-status message during the communication among the electronic devices of FIG. 1 in accordance with an embodiment of the present disclosure.

FIG. 6 is a flow diagram illustrating a method for functioning as a listening device for a group of electronic devices in accordance with an embodiment of the present disclosure.

FIG. 7 is a drawing illustrating communication among the electronic devices of FIG. 1 in accordance with an embodiment of the present disclosure.

FIG. 8 is a block diagram illustrating one of the electronic devices of FIG. 1 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In order to reduce the power consumption associated with waking and receiving beacons, a current listening device in a group of electronic devices wakes and scans for a beacon from another electronic device (such as an access point) using a wireless-local-area-network (WLAN) communication protocol (such as Wi-Fi®). Then, the current listening device transmits information associated with the beacon to the group of electronic devices using a second communication protocol (such as Bluetooth® Low Energy), which is different than the WLAN communication protocol and has a lower power consumption. Moreover, the current listening device receives, using the second communication protocol, a sequence of responses from the group of electronic devices indicating that the information was received, wherein the responses from different electronic devices are received at different times. For example, the responses may be received in a predefined order and/or in round-robin fashion for the group of electronic devices.

Because the other electronic devices in the group do not communicate using the higher power WLAN communication protocol, the power consumption of these electronic devices may be reduced. In addition, the current listening device may rotate through the group of electronic devices over time, so that, on average, the power consumption of the electronic device is also reduced. This reduction in the power consumption of the group of electronic devices may increase the battery life and/or the operating time of the group of electronic devices, which may improve the user experience.

In the discussion that follows, the beacons and the information are conveyed in packets that are received by radios in the current listening device and the other electronic devices in the group of electronic devices in accordance with a communication protocol, such as: an Institute of Electrical and Electronics Engineers (IEEE) 802.11 standard (which is sometimes referred to as Wi-Fi), Bluetooth (from the Bluetooth Special Interest Group of Kirkland, Wash.), Bluetooth Low Energy (BTLE) and/or another type of wireless interface. In the discussion that follows, Wi-Fi and BTLE are used as illustrative examples. However, a wide variety of communication protocols may be used.

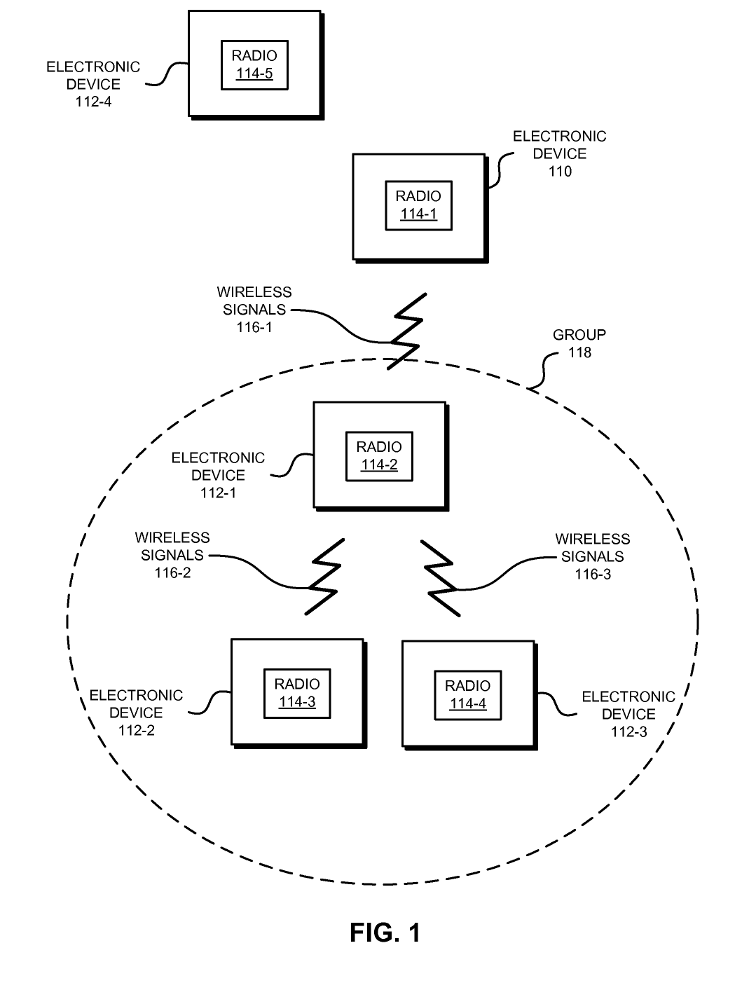

The communication among the electronic devices is shown in FIG. 1, which presents a block diagram illustrating electronic devices 110 and 112 wirelessly communicating. In particular, these electronic devices may wirelessly communicate while: detecting one another by scanning wireless channels, transmitting and receiving beacons or beacon frames on wireless channels, establishing connections (for example, by transmitting connect requests), and/or transmitting and receiving packets (which may include the request and/or additional information as payloads).

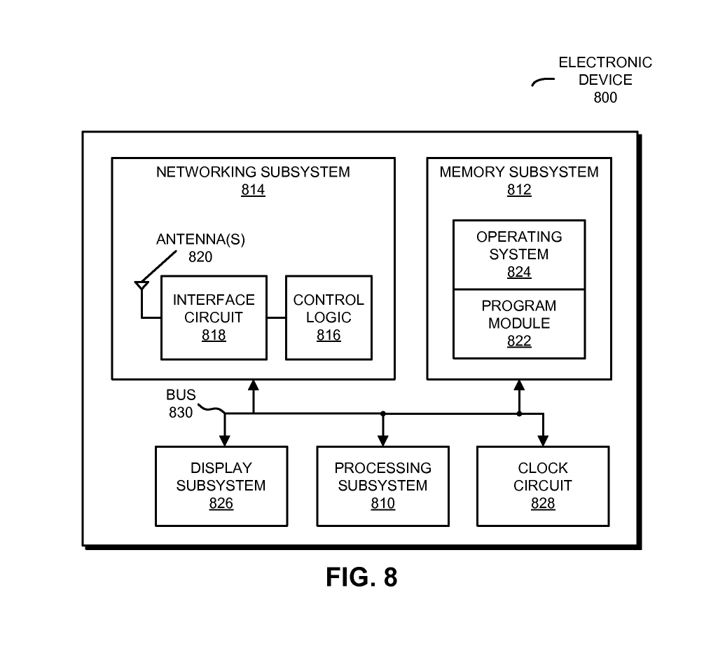

As described further below with reference to FIG. 8, electronic devices 110 and 112 may include subsystems, such as a networking subsystem, a memory subsystem and a processor subsystem. In addition, electronic devices 110 and 112 may include radios 114 in the networking subsystems. More generally, electronic devices 110 and 112 can include (or can be included within) any electronic devices with the networking subsystems that enable electronic devices 110 and 112 to wirelessly communicate with another electronic device. This can comprise transmitting beacons on wireless channels to enable electronic devices to make initial contact with or detect each other, followed by exchanging subsequent data/management frames (such as connect requests) to establish a connection, configure security options (e.g., IPsec), transmit and receive packets or frames via the connection, etc.

As can be seen in FIG. 1, wireless signals 116-1 (represented by a jagged line) are transmitted from a radio 114-1 in electronic device 110. These wireless signals 116-1 are received by radio 114-2 in electronic device 112-1. In particular, electronic device 110 (such as an access point) may broadcast or transmit beacons at transmit times. In turn, electronic device 112-1 (such as a smartphone) may receive one or more beacons, thereby detecting the presence of electronic device 110, by opening scan windows during the transmit times. This may allow electronic devices 110 and 112-1 to optionally establish a connection and communicate with each other. In addition, wireless signals 116-2 and 116-3 (represented by jagged lines) are transmitted by radio 114-2 in electronic device 112-1. These wireless signals 116 are received by radios 114-3 and 114-4 in electronic devices 112-2 and 112-3, respectively, which may subsequently reply to radio 114-2.

In the described embodiments, processing a packet or frame in either of electronic devices 110 and 112-1 includes: receiving wireless signals 116 with the packet or frame; decoding/extracting the packet or frame from received wireless signals 116 to acquire the packet or frame; and processing the packet or frame to determine information contained in the packet or frame (such as a beacon).

However, in order to receive the beacons transmitted by electronic device 110, a networking subsystem (such as an interface circuit) in electronic device 112-1 may need to be in an active or a high power-consumption mode. This may increase the power consumption and decrease the operating time of electronic device 112-1. Similarly, in existing approaches, if other electronic devices 112 want to receive the beacons transmitted by electronic device 110, networking subsystems in these electronic devices may also need to be in the active or the high power-consumption mode, with a commensurate impact on their power consumption and operating times.

In the communication technique described below, this problem is addressed by grouping electronic devices 112 into group 118 and using one member of group 118 (such as electronic device 112-1) as a current listening device (or master) for group 118. This current listening device (i.e., electronic device 112-1) may regularly transition from a low power-consumption state (such as a Wi-Fi sleep mode) to a higher power-consumption state (such as a wake or receive mode for Wi-Fi) to receive a beacon transmitted by electronic device 110 using Wi-Fi (and, more generally, a WLAN communication protocol). However, the other electronic devices in group 118 may not perform this operation. Instead, electronic device 112-1 may transmit information associated with the beacon to the other electronic devices in group 118 using BTLE, i.e., a second communication protocol that is different than the WLAN communication protocol and that has lower power consumption. In response, the other electronic devices in group 118 may transmit responses to electronic device 112-1 using BTLE, where each of the other electronic devices in group 118 transmits its response at a different time. For example, the responses may be transmitted in a predefined order for group 118. Alternatively or additionally, the responses may be transmitted in round-robin fashion from group 118.

After receiving the responses, electronic device 112-1 may transmit group status information about the other electronic devices in group 118. For example, the group status information may include: a list of the electronic devices in group 118; and a schedule indicating when the electronic devices in group 118 function as listening devices. In addition, electronic device 112-1 may trigger any of the other electronic devices in group 118 when there are designated frames for these electronic devices in electronic device 110 (such as in embodiments where electronic device 110 is an access point).

In some embodiments, the current listening device handles requests to join group 118. For example, electronic device 112-1 may receive a request from an additional electronic device (such as electronic device 112-4) to join group 118. In response to the request, electronic device 112-1 may add the additional electronic device to group 118.

As indicated previously, the current listening device may rotate through group 118 (e.g., based on the schedule). If electronic device 112-2 is subsequently the current listening device and electronic device 112-2 receives a beacon from electronic device 110, electronic device 112-2 may transmit the information associated with the beacon to the other electronic devices in group 118, including electronic device 112-1. When electronic device 112-1 receives this information, electronic device 112-1 may transmit a response to electronic device 112-2 that indicates the information was received. Once again, this transmission may be based on the predefined order for group 118.

In these ways, the communication technique may allow the other electronic devices in group 118 to save power while still maintaining their connections to Wi-Fi by receiving the information associated with the beacons (without directly using Wi-Fi to receive the beacons). Furthermore, by rotating the current listening device through group 118 over time, the average power consumption of group 118 (including electronic device 112-1) may be reduced, while still allowing group 118 to receive the information associated with the beacons transmitted by electronic device 110. For example, group 118 may maintain synchronization with electronic device 110. (Note that in some embodiments the synchronization occurs between electronic device 110 and the current listening device after or while electronic device 110 is detected without a connection being established between electronic device 110 and the current listening device. Thus, in the context of BTLE, there may not be bidirectional packet exchange between electronic device 110 and the current listening device in the communication technique.)

Note that, after scanning for the beacon, electronic device 112-1 may transition from the higher power-consumption state to the lower power-consumption state, such as from the wake or receive mode for Wi-Fi to the Wi-Fi sleep mode. Additionally, the other electronic device may transmit beacons at a time interval defined by a first period, and electronic device 112-1 (i.e., the current listening device) may scan for the beacons at a time interval defined by a second period, where the first period may be less than the second period. (Note that either or both of the use of the lower power-consumption state and the shorter first period which may also reduce the power consumption of electronic device 112-1.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

We now further describe the communication technique. As noted previously, regularly waking up an interface circuit in an electronic device to receive beacons consumes additional power. For example, if the beacons are transmitted by an access point every 102.4 or 104 ms (which, for simplicity, is approximated as 100 ms), an electronic device listens for or scans for beacons every 300-900 ms (which, as an example, is taken to be 900 ms), the current associated with power consumption in sleep mode is 135 μA, the current associated with power consumption in receive mode is 13 mA, and the processing time during the receive mode is 2-20 ms (which, as an example, is taken to be 10 ms), the average current associated with the additional power consumption is (10·13+(900−10)·0.0135)/900 or 0.278 mA.

This power consumption can be reduced using the communication technique. In particular, a group of N electronic devices (such as group 118 with N equal to 2, 6, 10, 16 or 32) may be established (e.g., using an ad-hoc technique in which proximate electronic devices that are within communication range ask the current listening device to join group 118) and then beacon listening by the current listening device may be scheduled (e.g., round-robin). Thus, the current listening device may rotate through group 118, thereby allowing group 118 to share listening for beacons using Wi-Fi. The current listening device may be awake and may scan for beacons during delivery traffic information message (DTIM) slots. Once a beacon ends, the current listening device may trigger the other N−1 electronic devices in group 118 using BTLE if there are designated frames for them in the access point. The current listening device may also provide, using BTLE, the timing synchronization function (TSF) for the access point to the other N−1 electronic devices in group 118. Note that the next ‘need to be listened to’ beacon may be handled by the ‘next’ current listening device in group 118. In this way, each electronic device in group 118 may wake on Wi-Fi every N·DTIM beacons. Therefore, the average current reduction associated with the power savings is (10·(N−1)/(900·N))·(13−0.0135) or 0.143·(N−1)/N mA.

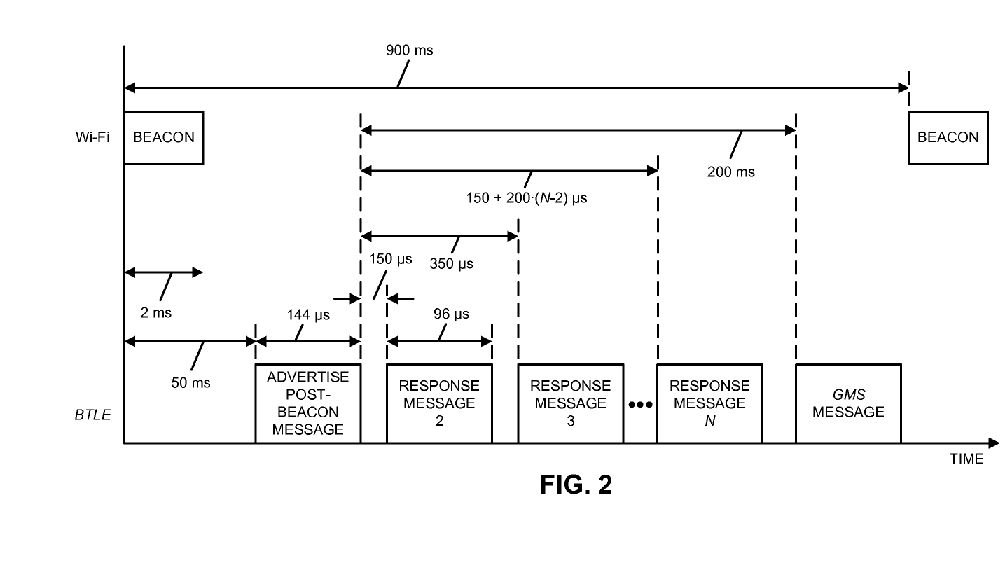

The communication technique is shown in FIG. 2, which presents a timing diagram illustrating communication among electronic devices 112 (FIG. 1). In particular, electronic device 110 (FIG. 1) transmits beacons using Wi-Fi. When the current listening device (such as electronic device 112-1 in FIG. 1) receives a beacon, the current listening device advertises the beacon information (in a post-beacon message) to the other electronic devices in group 118 (FIG. 1). In response, the other electronic devices in group 118 (FIG. 1) sequentially provide responses (in responses messages) to the current listening device. Then, the current listening device advertises information about group 118 (FIG. 1) using a group-member-status message.

In an exemplary embodiment, the beacons may have a duration of 2 ms and may be transmitted by electronic device 110 (FIG. 1) every 100 ms (which is the first period). The current listening device may scan for beacons with this period or using a longer period (which is the second period, and which is greater than or equal to the first period). For example, the current listening device may scan for beacons every 900 ms. Note that the second period may be configurable or programmable, and may depend on N.

Moreover, 50 ms after receiving the beacon, the current listening device may transmit the post-beacon message having a duration of 144 μs. After a 150 μs delay, response messages may be sequentially transmitted with a response period of 200 μs by the other electronic devices in group 118 (FIG. 1). In particular, during a given response period, there may be a response message from a given electronic device having a duration of 96 μs followed by a delay of 104 μs. Furthermore, 200 ms after the start of the post-beacon message, the current listening device may advertise the group-member-status message having a duration of 112 μs.

Group 118 (FIG. 1) may support tasks, such as: establishing group 118 (FIG. 1); choosing the current listening device (or the master); allowing an electronic device to be the voluntary master; allowing the master to be modified in time (for fairness); determining the current-listening-device schedule; updating the electronic-device identifiers in group 118 (FIG. 1) after each group check or BTLE wake up (which may be included in the group-member-status message); and/or handling electronic devices joining or leaving group 118 (FIG. 1). For example, for N equal to three, the current-listening-device schedule may have: a first electronic device in group 118 (FIG. 1) as the current listening device for times equal to 900+2700·n (where n is an integer); a second electronic device in group 118 (FIG. 1) as the current listening device for times equal to 1800+2700·n (where n is an integer); and a third electronic device in group 118 (FIG. 1) as the current listening device for times equal to 2700+2700·n (where n is an integer). Moreover, for N equal to five, the group members may be enumerated as one through five, and the first electronic device in group 118 (FIG. 1) may establish and maintain group 118 (FIG. 1), including: allocating member identifiers (such as random numbers, the largest or smallest of which may specify the current listening device) to each member of group 118 in FIG. 1 (and, thus, determining the current listening device and the response order); adding new electronic devices to the group list and providing the identifiers of the members to the new electronic devices; and/or, at each BTLE wake up, checking that group 118 (FIG. 1) is unchanged. Thus, if the first electronic device in group 118 (FIG. 1) is the current listening device and the third electronic device in group 118 (FIG. 1) does not reply to the group check in the post-beacon message, the first electronic device may become the fourth electronic device, the second electronic device may become the first electronic device (i.e., the current listening device), the fourth electronic device may become the second electronic device, and the fifth electronic device may become the third electronic device.

Note that the electronic devices in group 118 (FIG. 1) may be used with or without a companion device (such as the combination of a cellular telephone and a low-power electronic device). When a companion device is present, the companion device may perform all of the interaction with the network. In particular, a single companion device may act as a Wi-Fi intermediary for the members of group 118 (FIG. 1) when the members are in sleep mode. In general, the communication technique may be used when there is no companion device or if the companion device is switched off. In these cases, the current listening device acts as the Wi-Fi intermediary for the members of group 118 (FIG. 1). This capability may be useful: at meetings where cellular telephones are disturbing or impolite (i.e., in environments where cellular telephones and, more generally, portable electronic devices should be turned off or are not permitted).

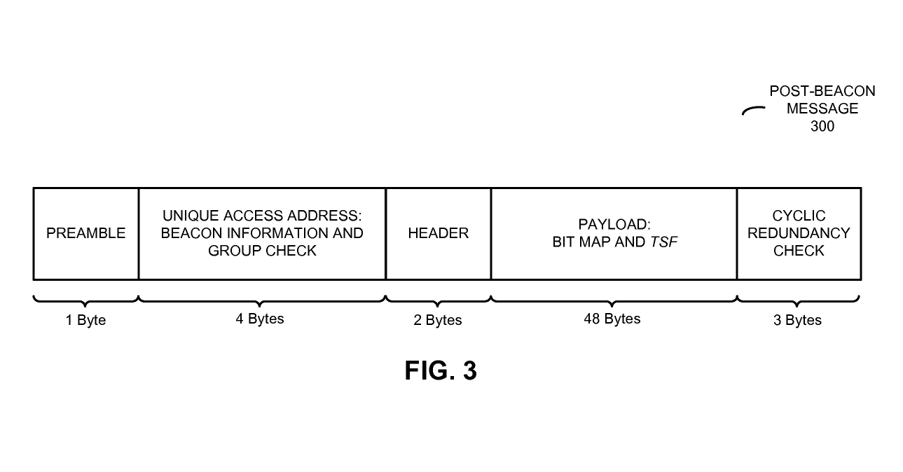

We now describe the messages communicated among the group of N electronic devices (such as group 118 in FIG. 1). FIG. 3 presents a drawing illustrating a post-beacon message 300 during the communication among electronic devices 112 (FIG. 1). In particular, the current listening device may advertise the following information: any designated frames for an electronic device pending in the access point (e.g., 1′b1 in index i may indicate that the access point has a frame ready for device i, so that device i exits sleep mode); the TSF counter for clock synchronization (which may be optional when N is small); and/or the group status check. Note that post-beacon message 300 may have a total length of 18 B or a duration of 144 μs.

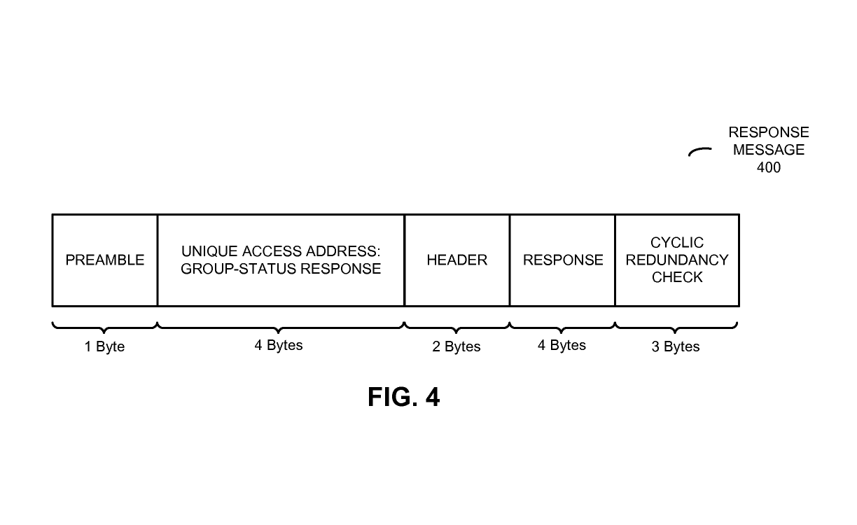

FIG. 4 presents a drawing illustrating a response message 400 during the communication among electronic devices 112 (FIG. 1). In particular, group members that are in Wi-Fi power-saving or sleep mode may reply to the advertised post-beacon message with a response at a predefined time slot using BTLE. The response from a given electronic device may include: a group member index, and an indication of the role of the given electronic device in the group for the next DTIM (such as ‘next current listening device,’ ‘standby,’ and ‘sleep’). Note that response message 400 may have a total length of 12 B or a duration of 96 μs.

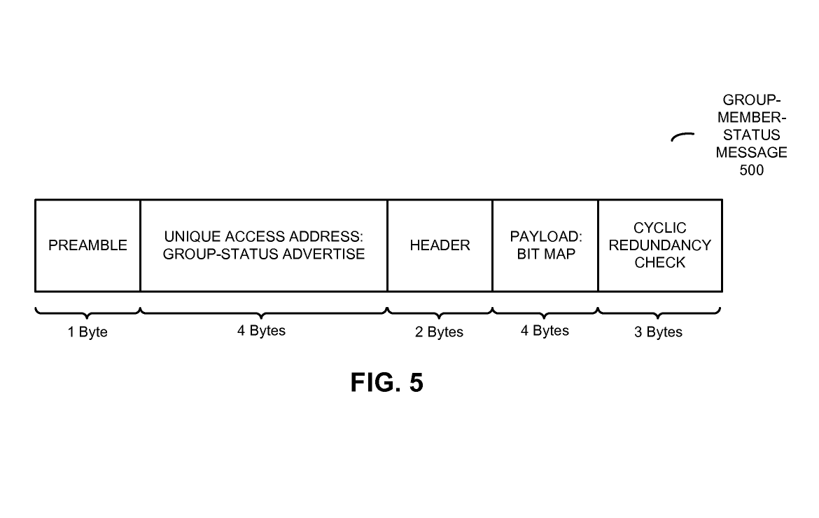

FIG. 5 presents a drawing illustrating a group-member-status (GMS) message 500 during the communication among electronic devices 112 (FIG. 1). In particular, the current listening device may advertise group member status because the group may have dynamically changed. For example, the group-member status or group status information may include: a list of the electronic devices in the group of N electronic devices; and/or a schedule indicating when the electronic devices in the group function as listening devices. Note that group-member-status message 500 may have a total length of 14 B or a duration of 112 μs.

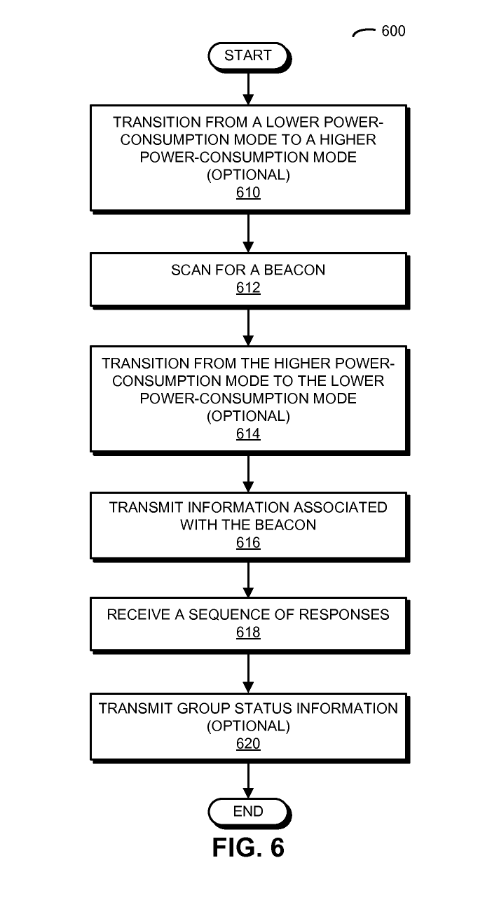

We now further describe the communication technique. FIG. 6 presents a flow diagram illustrating a method 600 for functioning as a listening device for a group of electronic devices (such as group 118 in FIG. 1), which may be performed by an electronic device (such as the current listening device, e.g., electronic device 112-1 in FIG. 1). During operation, the electronic device optionally transitions from a lower power-consumption mode to a higher power-consumption mode (operation 610). Then, the electronic device scans for a beacon (operation 612) transmitted by another electronic device using a WLAN communication protocol (such as Wi-Fi). Moreover, the electronic device optionally transitions from the higher power-consumption mode to the lower power-consumption mode (operation 614).

Next, the electronic device transmits information associated with the beacon (operation 616) to the group of electronic devices using a second communication protocol (such as BTLE), where the second communication protocol is different than the WLAN communication protocol. Furthermore, the electronic device receives, using the second communication protocol, a sequence of responses (operation 618) from the group of electronic devices indicating that the information was received, where the responses from the different electronic devices are received at different times.

In some embodiments, after receiving the sequence of responses (operation 618), the electronic device optionally transmits group status information (operation 620) about electronic devices in the group of electronic devices. Additionally, the electronic device may optionally perform additional operations. For example, the electronic device may: receive a request from an additional electronic device to join the group of electronic devices; and, in response to the request, adds the additional electronic device to the group of electronic devices.

In these ways, the electronic devices (for example, interface circuits and/or drivers in the electronic devices) may facilitate communication between the electronic devices with reduced power consumption. In particular, scanning for beacons may only be performed by a designated current listening device, which may allow interface circuits in the other electronic devices to spend less time in a high power-consumption mode.

In some embodiments of method 600 there are additional or fewer operations. Moreover, the order of the operations may be changed, and/or two or more operations may be combined into a single operation.

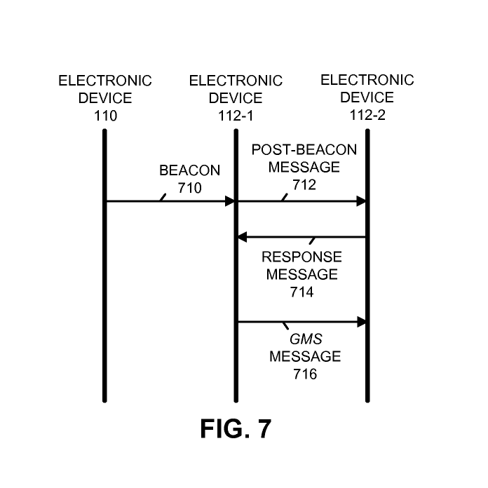

The communication technique is further illustrated in FIG. 7, which presents a flow diagram illustrating a method for communication among the electronic devices of FIG. 1, such as electronic device 110 communicating with electronic device 112-1, and electronic device 112-1 communicating with the other electronic devices in group 118 in FIG. 1 (e.g., electronic device 112-2). During operation, electronic device 110 may transmit a beacon 710 to electronic device 112-1 at a transmit time. In turn, electronic device 112-1 may receive beacon 710 by opening a scan window having a width at a window time.

When a beacon (such as beacon 710) is received, electronic device 112-1 may transmit information associated with beacon 710 to electronic device 112-2 in post-beacon message 712. Then, electronic device 112-2 may transmit response message 714 to electronic device 112-1 (which is one of a sequence of response messages from the group of electronic devices). Moreover, electronic device 112-1 may transmit group-member-status (GMS) message 716 to electronic device 112-2.

We now describe embodiments of the electronic device. FIG. 8 presents a block diagram illustrating an electronic device 800, such as one of electronic devices 110 and 112 in FIG. 1. This electronic device includes processing subsystem 810, memory subsystem 812, and networking subsystem 814. Processing subsystem 810 includes one or more devices configured to perform computational operations. For example, processing subsystem 810 can include one or more microprocessors, application-specific integrated circuits (ASICs), microcontrollers, programmable-logic devices, and/or one or more digital signal processors (DSPs).

Memory subsystem 812 includes one or more devices for storing data and/or instructions for processing subsystem 810 and networking subsystem 814. For example, memory subsystem 812 can include dynamic random access memory (DRAM), static random access memory (SRAM), and/or other types of memory. In some embodiments, instructions for processing subsystem 810 in memory subsystem 812 include: one or more program modules or sets of instructions (such as program module 822 or operating system 824), which may be executed by processing subsystem 810. Note that the one or more computer programs may constitute a computer-program mechanism. Moreover, instructions in the various modules in memory subsystem 812 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 810.

In addition, memory subsystem 812 can include mechanisms for controlling access to the memory. In some embodiments, memory subsystem 812 includes a memory hierarchy that comprises one or more caches coupled to a memory in electronic device 800. In some of these embodiments, one or more of the caches is located in processing subsystem 810.

In some embodiments, memory subsystem 812 is coupled to one or more high-capacity mass-storage devices (not shown). For example, memory subsystem 812 can be coupled to a magnetic or optical drive, a solid-state drive, or another type of mass-storage device. In these embodiments, memory subsystem 812 can be used by electronic device 800 as fast-access storage for often-used data, while the mass-storage device is used to store less frequently used data.

Networking subsystem 814 includes one or more devices configured to couple to and communicate on a wired and/or wireless network (i.e., to perform network operations), including: control logic 816, an interface circuit 818 and one or more antennas 820. For example, networking subsystem 814 can include a Bluetooth networking system, a cellular networking system (e.g., a 3G/4G network such as UMTS, LTE, etc.), a universal serial bus (USB) networking system, a networking system based on the standards described in IEEE 802.11 (e.g., a Wi-Fi networking system), an Ethernet networking system, and/or another networking system.

Networking subsystem 814 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 800 may use the mechanisms in networking subsystem 814 for performing simple wireless communication between the electronic devices, e.g., transmitting advertising or beacon frames and/or scanning for advertising frames transmitted by other electronic devices as described previously.

Within electronic device 800, processing subsystem 810, memory subsystem 812, and networking subsystem 814 are coupled together using bus 830. Bus 830 may include an electrical, optical, and/or electro-optical connection that the subsystems can use to communicate commands and data among one another. Although only one bus 830 is shown for clarity, different embodiments can include a different number or configuration of electrical, optical, and/or electro-optical connections between the subsystems.

In some embodiments, electronic device 800 includes a display subsystem 826 for displaying information on a display, which may include a display driver and the display, such as a liquid-crystal display, a multi-touch touchscreen, etc. In addition, electronic device 800 may include clock circuit 828 that outputs a clock. Note that clock circuit 828 may be included in a GPS circuit.

Electronic device 800 can be (or can be included in) any electronic device with at least one network interface. For example, electronic device 800 can be (or can be included in): a desktop computer, a laptop computer, a server, a media player (such as an MP3 player), an appliance, a subnotebook/netbook, a tablet computer, a smartphone, a cellular telephone, a piece of testing equipment, a network appliance, an access point, a set-top box, a personal digital assistant (PDA), a toy, a controller, a digital signal processor, a game console, a computational engine within an appliance, a consumer-electronic device, a portable computing device, a personal organizer, a sensor, a user-interface device and/or another electronic device.

Although specific components are used to describe electronic device 800, in alternative embodiments, different components and/or subsystems may be present in electronic device 800. For example, electronic device 800 may include one or more additional processing subsystems 810, memory subsystems 812, networking subsystems 814, and/or display subsystems 826. Additionally, one or more of the subsystems may not be present in electronic device 800. Moreover, in some embodiments, electronic device 800 may include one or more additional subsystems that are not shown in FIG. 8. For example, electronic device 800 can include, but is not limited to, a data collection subsystem, an audio and/or video subsystem, an alarm subsystem, a media processing subsystem, and/or an input/output (I/O) subsystem. Also, although separate subsystems are shown in FIG. 8, in some embodiments, some or all of a given subsystem or component can be integrated into one or more of the other subsystems or component(s) in electronic device 800. For example, in some embodiments program module 822 is included in operating system 824.

Moreover, the circuits and components in electronic device 800 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 814, such as a radio. Moreover, the integrated circuit may include hardware and/or software mechanisms that are used for transmitting wireless signals from electronic device 800 and receiving signals at electronic device 800 from other electronic devices. Aside from the mechanisms herein described, radios are generally known in the art and hence are not described in detail. In general, networking subsystem 814 and/or the integrated circuit can include any number of radios. Note that the radios in multiple-radio embodiments function in a similar way to the described single-radio embodiments.

In some embodiments, networking subsystem 814 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, etc.)

While communication protocols compatible with Wi-Fi and BTLE standards were used as illustrative examples, the described embodiments of the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication technique may be implemented using program module 822, operating system 824 (such as a driver for interface circuit 818) and/or in firmware in interface circuit 818. Alternatively or additionally, at least some of the operations in the communication technique may be implemented in a physical layer, such as hardware in interface circuit 818.

Moreover, the communication technique may be used in a wide variety of applications, such as consumer electronics, communication, the Internet of Things, etc.

In the preceding description, we refer to ‘some embodiments.’ Note that ‘some embodiments’ describes a subset of all of the possible embodiments, but does not always specify the same subset of embodiments. Moreover, note that the numerical values provided are intended as illustrations of the communication technique. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A first electronic device, comprising:
an antenna; and
an interface circuit, coupled to the antenna, configured to communicate with a second electronic device and a group of electronic devices, wherein the first electronic device functions as a listening device for the group of electronic devices, and wherein the interface circuit is configured to:
scan for a beacon transmitted by the second electronic device using a wireless local area network (WLAN) communication protocol;
transmit information associated with the beacon to the group of electronic devices using a second communication protocol, wherein the second communication protocol is different than the WLAN communication protocol; and
receive, using the second communication protocol, a sequence of responses from the group of electronic devices indicating that the information was received, wherein the responses from different electronic devices are received at different times.

2. The electronic device of claim 1, wherein the second communication protocol is associated with lower power consumption than the WLAN communication protocol.

3. The electronic device of claim 1, wherein the WLAN communication protocol includes Wi-Fi® and the second communication protocol includes Bluetooth® Low Energy.

4. The electronic device of claim 1, wherein, after receiving the responses, the interface circuit is configured to transmit group status information about electronic devices in the group of electronic devices.

5. The electronic device of claim 4, wherein the group status information includes: a list of the electronic devices in the group of electronic devices; and a schedule indicating when the electronic devices in the group of electronic devices function as listening devices.

6. The electronic device of claim 1, wherein, when a third electronic device in the group of electronic devices other than the first electronic device functions as the listening device, the interface circuit is configured to:
receive information associated with another beacon from the third electronic device; and
transmit a response to the third electronic device that indicates the information was received, wherein the response is transmitted in a predefined order for the group of electronic devices.

7. The electronic device of claim 1, wherein, prior to scanning for the beacon, the interface circuit is configured to transition from a lower power-consumption mode to a higher power-consumption mode.

8. The electronic device of claim 7, wherein, after scanning for the beacon, the interface circuit is configured to transition from the higher power-consumption mode to the lower power-consumption mode.

9. The electronic device of claim 1, wherein the interface circuit is configured to:
receive a request from a third electronic device to join the group of electronic devices; and
in response to the request, add the third electronic device to the group of electronic devices.

10. The electronic device of claim 1, wherein the responses are received in a predefined order for the group of electronic devices.

11. The electronic device of claim 1, wherein the responses are received in round-robin fashion from the group of electronic devices.

12. The electronic device of claim 1, wherein the second electronic device transmits beacons at a time interval defined by a first period; and
wherein the first electronic device scans for the beacons at a time interval defined by a second period.

13. The electronic device of claim 12, wherein the first period is less than the second period.

14. The electronic device of claim 1, wherein the second electronic device includes an access point.

15. A first electronic device, comprising:
an antenna;
an interface circuit, coupled to the antenna, configured to communicate with a second electronic device and a group of electronic devices that includes the first electronic device;
a processor; and
memory coupled to the processor, wherein the memory stores a program module, and wherein the program module is configured to be executed by the processor to function as a listening device for the group of electronic devices, the program module including:
instructions for scanning for a beacon transmitted by the second electronic device using a wireless local area network (WLAN) communication protocol;
instructions for transmitting information associated with the beacon to the group of electronic devices using a second communication protocol, wherein the second communication protocol is different than the WLAN communication protocol; and
instructions for receiving, using the second communication protocol, a sequence of responses from the group of electronic devices indicating that the information was received, wherein the responses from different electronic devices are received at different times.

16. The electronic device of claim 15, wherein the second communication protocol is associated with lower power consumption than the WLAN communication protocol.

17. The electronic device of claim 15, wherein the program module includes, after the instructions for receiving the responses, instructions for transmitting group status information about electronic devices in the group of electronic devices.

18. The electronic device of claim 15, wherein the program module includes, prior to the instructions for scanning for the beacon, instructions for transitioning from a lower power-consumption mode to a higher power-consumption mode; and
wherein the program module includes, after the instructions for scanning for the beacon, instructions for transitioning from the higher power-consumption mode to the lower power-consumption mode.

19. The electronic device of claim 15, wherein the responses are received in a predefined order for the group of electronic devices.

20. A method for functioning as a listening device for a group of electronic devices, wherein the method comprises:
scanning for a beacon transmitted by an electronic device using a wireless local area network (WLAN) communication protocol;
transmitting information associated with the beacon to the group of electronic devices using a second communication protocol, wherein the second communication protocol is different than the WLAN communication protocol; and
receiving, using the second communication protocol, a sequence of responses from the group of electronic devices indicating that the information was received, wherein the responses from different electronic devices are received at different times.
